(19) United States
(12) Patent Application Publication
(10) Pub. No.: US 2008/0271235 A1
(43) Pub. Date: Nov. 6, 2008

(54) NOVEL ENHANCED POOL SYSTEM PROCESSES AND PRODUCTS THEREBY

(76) Inventors: Gregory D. Trimarche, Laguna Beach, CA (US); Melissa Trimarche, Laguna Beach, CA (US)

Correspondence Address: GREENBERG TRAURIG LLP (LA), 2450 COLORADO AVENUE, SUITE 400E, INTELLECTUAL PROPERTY DEPARTMENT, SANTA MONICA, CA, 90404, US

(21) Appl. No.: 12/113,820

(22) Filed: May 1, 2008

Related U.S. Application Data
(60) Provisional application No. 60/915,299, filed on May 1, 2007.
(60) Provisional application No. 61/013,935, filed on Dec. 14, 2007.

(51) Int. Cl. E04H 4/00; G06Q 20/00; G06Q 30/00

(52) U.S. Cl. 4/494; 705/27; 705/14

(57) ABSTRACT

Briefly stated, a pool to be assembled and emplaced in a slightly concaved location is available in a container. Similarly, an integrated beach cart and cooler system can house the self-assembly pool, and various other articles enabling parents to travel to and from the beach. Process, products and electronic commerce methods thereby are likewise disclosed, allowing consumers to make informed choices to review and purchase the instant teachings conveniently. A customer rewards function is exchanged for data-sharing about age and size of children to allow creation of a database of children for ongoing monitoring of upcoming purchasing needs.

### RELATED APPLICATIONS

This application claims the benefit of and priority to U.S. Provisional Application Ser. No(s). 60/915,299, filed May 1, 2007 and 61/013,935, filed Dec. 14, 2007, the contents of each of which are incorporated by reference herein in its entirety. All Paris Convention rights are expressly reserved with respect to the instant filing and said priority claims.

### BACKGROUND OF THE DISCLOSURE

The present disclosure relates to temporary, leisure based play activities and entertainment systems, particularly for children. The present disclosure teaches how to transport and create pools at the beach, or any setting having analogous local climate and geography.

The present disclosure is directed to pools easily constructible by any parent and readily removable, in a temporary setting, particularly the beach. In particular, the present invention relates to systems, portable kits, processes and products to enable pools to be readily transported, un-packed, set-up, and re-packed. Likewise, given the nature of the instant teachings, an integrated beach cart and cooler functions well in combination with the same.

Known portable pools, for example, those for children, are generally comprised of a rigid shell. This makes it inconvenient to transport them over distance, for example from one's home or vehicle to the beach. Likewise, having mechanisms which support parental supervision at the beach without losing the freedom and nature inherent in said space have become a longstanding need in the field. These issues are addressed by the teachings of the instant disclosure. Being able to transport the container or bucket which house the foldable pool is yet another benefit of the instant teachings.

In contradiction to the disclosure herein, other portable systems cannot be folded into single containers. Modular systems are also known, but none are commercially available which would allow a parent to go to the beach without so many moving parts as to lower the relaxation value of the trip. No systems combining these two desiderata are known, or could be found, or have any commercially available counterparts. Accordingly, the teachings of the present disclosure are offered for consideration to address the ongoing need for beach pools for children, toddlers, infants and those for whom the foreboding nature of the surf may be dangerous.

### SUMMARY OF THE DISCLOSURE

Briefly stated, a pool to be assembled and emplaced in a slightly concaved location is available in a container. Process, products and e-commerce related methods thereby are disclosed. Likewise, a combination integrated beach cart and cooler functions ideally with the present disclosure.

The present inventors have discovered that longstanding needs are satisfied by a pool to be assembled and emplaced in a slightly concaved location made available in a container. Processes, products and methods thereby are disclosed, such that parents can assemble a pool at the beach.

The present disclosure permits a portable system to be easily packed-up and carried, for example to the beach, where a user simply and efficiently assembles and fills (and later disassembles) it, allowing children to swim in it without leaving the security of the zone where waves do not crash.

According to embodiments of the present disclosure a portable system to be easily laid out by removing and unfolding a foldable sheet from a portable kit and placing the sheet within a concave location and optionally reinforcing the perimeter with stakes and filling with water, is disclosed. A process for creating a portable and temporary beach pool, comprising, in combination providing a foldable sheet effective to be housed within a bucket-like container; supplying a flexible border assembly, including looped aperture creating attachments disposed about the circumference thereof, which defines a perimeter for the foldable sheet, whereby sand from a beach surface is separated from an inner pool space by the border assembly; further providing a plurality of stake members likewise housed within the bucket-like container; aligning the foldable sheet and flexible border assembly at a desired location, on an appropriate substrate, within a concave area; and attaching the foldable sheet and flexible border assembly to the appropriate substrate by driving the stake members through the looped aperture creating attachments until a tensioned pool-device is created.

According to embodiments there is provided a kit, comprising, in combination at least a container having a handle, divided into upper and lower halves by a trough defining an extension past the outer surface of the container; a foldable sheet/liner having flexible plastic tubing disposed about its perimeter which is bracingly received by the trough of the bucket in transit; a plurality of plastic stake members easily arranged in the lower half of the container beneath the foldable sheet/liner; and directions for use and accessories likewise housed within the at least a container.

According to embodiments, there is provided a kit as discussed above and claimed below, wherein said liner/foldable sheet is offered in at least one size selected from ranges of at least about three feet in diameter to about five feet in diameter.

According to embodiments a kit is offered which further comprises:

### DRAWINGS

The above-mentioned features and objects of the present disclosure will become more apparent with reference to the following description taken in conjunction with the accompanying drawings wherein like reference numerals denote like elements and in which:

FIG. 1 is schematic of the instant disclosure as set up on a beach; and

FIG. 2 is a schematic of the instant disclosure in a first state, where it is assembled in a container, according to teachings of the instant embodiments.

### DETAILED DESCRIPTION

The present inventor has discovered that temporary pool structures can be carried in a single container and un-packed and assembled, for example at the beach, with a small number of parts, which structure can be disassembled and re-packed simply and efficiently. Likewise, in combination with an integrated beach cart and cooler, a parent can pick up the pool, food and beverages and be able to travel to a beach while supervising young children.

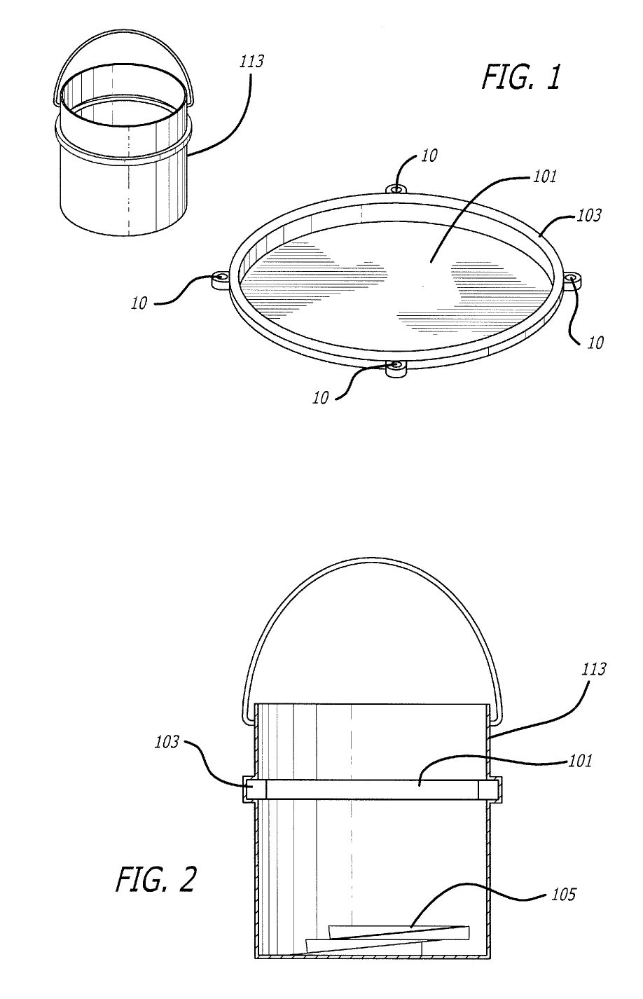

Referring now to FIG. 1, there is shown a schematic of the pool in an assembled state. Liner/foldable sheet 101, is bordered by perimeter strip 103, and held in place by stakes 105 through apertures 108 loops for attaching stakes. Water (not shown), is easily transported with any conventional vessel, or container 113, which houses liner/foldable sheet 101 and also is used to excavate depression to hold liner. By way of example, the depth can be controlled so that an infant, toddler, or older child can be monitored, cooled, and allowed to play on a blanket/towel away from the surf.

Referring now also to FIG. 2, container 113 is effective for housing the Liner/foldable sheet 101, including perimeter strip 103, and stakes 105. Artisans will understand that un-packing and re-packing liner/foldable sheet 101, including perimeter strip 103, and stakes 105, is easily done. Those skilled in the art readily understand that those sizes needed for children from the toddler stage on can be made with the teachings of the present disclosure. Likewise, the present inventors have assembled a suite of products, including an improved cooler which functions along with the teachings of the present disclosure. Spaces above stakes 105 allow for the storage of other articles and their respective transport.

Similarly, other aspects of those products offered herein are compatible with a suite of leisure products, including disposable and biodegradable beach toys and cutlery and various other items, which can be transported with, used with and otherwise function with the instant disclosure.

FIG. 2 also shows container 113 and liner/foldable sheet 101, parameter strip 103 and stakes as arranged in one embodiment. Artisans understand that the “bucket” shown is but one embodiment of the instant teachings.

Conventional children's toy sets may be adapted for use as the instant system, for example, elements of the Prince Lionhart™ brand of POPUPS® tent, with minor modifications, can be used to create the foldable sheet set, if structural members are removed. Those skilled in the art will understand that being foldable, and easily assembled, disassembled, and reassembled are integral functions of the instant system. Similarly, Velcro® be and of closure systems, zippers, and the like fastener are contemplated by the instant disclosure. Owing to the simplicity and ease of operations, one can use the system of the present disclosure, clean it and put it away for next time. The elegance of the system by any parent, is easily appreciated.

Those skilled in the art readily understand that electronic commerce enables customers to “surf the net” and find desired articles. According to the instant teachings customers or potential clients may view the articles of the present invention. Since catalogs and advertisements often do not show exactly how wonderful items are, the instant system also uses retail outlets housing the goods to show and tell to prospective users. Likewise, in exchange for providing information about children's age and sizes (enabling seller to track when new items may be acquired), credits, give-a-ways, or other customer rewards may be issued.

While the apparatus and method have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

It should also be understood that a variety of changes may be made without departing from the essence of the invention. Such changes are also implicitly included in the description. They still fall within the scope of this invention. It should be understood that this disclosure is intended to yield a patent covering numerous aspects of the invention both independently and as an overall system and in both method and apparatus modes.

Further, each of the various elements of the invention and claims may also be achieved in a variety of manners. This disclosure should be understood to encompass each such variation, be it a variation of an embodiment of any apparatus embodiment, a method or process embodiment, or even merely a variation of any element of these.

Particularly, it should be understood that as the disclosure relates to elements of the invention, the words for each element may be expressed by equivalent apparatus terms or method terms—even if only the function or result is the same.

Such equivalent, broader, or even more generic terms should be considered to be encompassed in the description of each element or action. Such terms can be substituted where desired to make explicit the implicitly broad coverage to which this invention is entitled.

It should be understood that all actions may be expressed as a means for taking that action or as an element which causes that action.

Similarly, each physical element disclosed should be understood to encompass a disclosure of the action which that physical element facilitates.

Any patents, publications, or other references mentioned in this application for patent are hereby incorporated by reference. In addition, as to each term used it should be understood that unless its utilization in this application is inconsistent with such interpretation, common dictionary definitions should be understood as incorporated for each term and all definitions, alternative terms, and synonyms such as contained in at least one of a standard technical dictionary recognized by artisans and the Random House Webster's Unabridged Dictionary, latest edition are hereby incorporated by reference.

Finally, all references listed in the Information Disclosure Statement or other information statement filed with the application are hereby appended and hereby incorporated by reference; however, as to each of the above, to the extent that such information or statements incorporated by reference might be considered inconsistent with the patenting of this/these invention(s), such statements are expressly not to be considered as made by the applicant(s).

In this regard it should be understood that for practical reasons and so as to avoid adding potentially hundreds of claims, the applicant has presented claims with initial dependencies only.

Support should be understood to exist to the degree required under new matter laws—including but not limited to U.S. Patent Law 35 USC 132 or other such laws—to permit the addition of any of the various dependencies or other elements presented under one independent claim or concept as dependencies or elements under any other independent claim or concept.

To the extent that insubstantial substitutes are made, to the extent that the applicant did not in fact draft any claim so as to literally encompass any particular embodiment, and to the extent otherwise applicable, the applicant should not be understood to have in any way intended to or actually relinquished such coverage as the applicant simply may not have been able to anticipate all eventualities; one skilled in the art, should not be reasonably expected to have drafted a claim that would have literally encompassed such alternative embodiments.

Further, the use of the transitional phrase “comprising” is used to maintain the “open-end” claims herein, according to traditional claim interpretation. Thus, unless the context requires otherwise, it should be understood that the term “compromise” or variations such as “comprises” or “comprising”, are intended to imply the inclusion of a stated element or step or group of elements or steps but not the exclusion of any other element or step or group of elements or steps.

Such terms should be interpreted in their most expansive forms so as to afford the applicant the broadest coverage legally permissible.

1. A process for creating a portable and temporary beach pool, comprising, in combination:
providing a liner/foldable sheet effective to be housed within a bucket-like container;
the liner/foldable sheet being integral with a flexible border assembly, including looped aperture creating attachments disposed about the circumference thereof, which defines a perimeter for the liner/foldable sheet, whereby sand from a beach surface is separated from an inner pool space by the border assembly;
supplying a plurality of stake members likewise housed within the bucket-like container;
aligning the liner/foldable sheet and flexible border assembly at a desired location, on an appropriate substrate, within a concave area; and
attaching the liner/foldable sheet and flexible border assembly to the appropriate substrate by driving the stake members through the looped aperture creating attachments until a tensioned pool-device is created.

2. The process of claim 1, whereby the liner/foldable sheet ranges from a dimension of at least about three feet to greater than five feet in diameter.

3. The process of claim 2, whereby the aligning step further comprises a concavity depth ranging from at least about eight inches deep to approximately twenty-four inches deep.

4. The process of claim 3, wherein the foldable sheet functions as a liner of the pool created, being impermeable such that it is effective to sustain a desired quantity of water therein.

5. The process of claim 4, wherein the bucket-like container further comprises additional closure and attachment mechanisms consisting essentially of zipper-type fastening systems, Velcro®-brand of fastening systems, buttons, snaps, clips and related devices enabling the bucket-like container to be transported housing the foldable sheet, flexible border assembly and stakes as an integral unit.

6. The process of claim 5, wherein the diameter and depth, concave distance from the top of the water surface to the liner are adjustable based upon at least one of the age and size of intended users.

7. Products, by the process of claim 6.

8. A kit, comprising, in combination:
at least a container having a handle, divided into upper and lower halves by a trough defining an extension past the outer surface of the container;
a foldable sheet/liner having flexible plastic tubing disposed about its perimeter which is bracingly received by the trough of the bucket in transit;
a plurality of plastic stake members easily arranged in the lower half of the container beneath the foldable sheet/liner; and
directions for use and accessories likewise housed within the at least a container.

9. The kit, as defined by claim 8, wherein said at least a container has a capacity ranging from at least about two to approximately four gallons of volume.

10. The kit, as defined by claim 9, wherein the flexible plastic tubing further comprises at least two looped aperture creating attachments disposed opposite each other along the periphery.

11. The kit, as defined by claim 10, having four looped aperture creating attachments.

12. The kit, as defined by claim 11, wherein the liner/foldable sheet is dimensional to fold into circular patterns whereby successive folds generate a finished arrangement having a diameter of at least about eighteen inches, for firm attachment into the trough which divides the container into top and bottom halves.

13. The kit as defined in claim 12, wherein said liner/foldable sheet is offered in at least one size selected from ranges of at least about three feet in diameter to about five feet in diameter.

14. The kit, as defined in claim 13, wherein the resultory pool ranges from at least about nine inches to about twenty-four inches in depth.

15. An electronic commerce method comprising, in combination:
providing access to a site offering for consideration at least a plurality of leisure articles;
directing consumers to at least one of a catalog and a local retail location proximate to an ocean, lake or other source of beachfront real-estate to review benefits, features and advantages of said at least a plurality of leisure articles;
accepting electronic payments; and shipping articles paid for to the consumers;
wherein the articles are comprised of at least one beach-based item purchase selected from the group consisting of a self-assembly beach-pool kit, a transport mechanism for the self-assembly beach-pool kit and related accessories, including biodegradable cutlery and biodegradable beach toys for children.

16. The electronic commerce method and claim is, further comprised of a database of children's ages input in exchange for at least one of rewards and credits for providing the children's age and size data.

17. A system for transport and beach pool self-assembly, comprising, in combination:
at least a container housing a foldable pool;
an improved beach-friendly cooler device having large soft wheels;
wherein the at least a container and the beach-friendly cooler device can be packed and provide improved ingress to and return from a beach area.

18. A kit, comprising:
a self-assembly beach pool system housed in a bucket-like container, and
a transport mechanism to allow the self-assembly beach pool system and food with beverages to be transported to the beach;
the transport mechanism being composed of an integrated beach cart and cooler.

19. The kit, of claim 18, wherein said integrated beach cart and cooler comprising a plurality of ballooned-tires, a telescoping handle assembly and a plurality of receptacles, clamps and related holder mechanisms to house items to be transported to the beach.
